(19) United States
(12) Patent Application Publication
(10) Pub. No.: US 2016/0171185 A1
(43) Pub. Date: Jun. 16, 2016

(54) Correlated Virtual Arts and Crafts Venue

(71) Applicant: Staci Daniel, Zephyr Cove, NV (US)

(72) Inventor: Staci Daniel, Zephyr Cove, NV (US)

(21) Appl. No.: 14/967,194

(22) Filed: Dec. 11, 2015

Related U.S. Application Data
(60) Provisional application No. 62/090,795, filed on Dec. 11, 2014.

(51) Int. Cl. G06F 21/10; G06Q 50/18; G06Q 10/06; G06F 17/30; G06Q 30/06

(52) U.S. Cl. CPC G06F 21/10; G06F 17/30864; G06Q 30/0643; G06Q 10/06; G06Q 50/184

(57) ABSTRACT

The present invention provides a system to create, promote, optimize, and manage virtual art fairs. The system comprises software modules used to manage implementation of the system in a manner that can rapidly scale to accommodate increasing numbers of users and data. An orchestrator module manages the overall operation of the modules. An administrative module manages registration, billing, and other administrative elements of the system. A jury module evaluates submissions. A cycling module ensures artistic content is fresh, limited, and non-repetitive. A correlation module extends connectivity from a brick and mortar art fair to the virtual art fair. A virtual exhibit module provides templates and tools to support the setup of a virtual tent that includes digital representations of the works of artists. A notification module notifies users of artists' rights and entitlements. An intellectual property protection module searches and identifies potentially infringing use of content submissions on the Internet.

### CROSS REFERENCE TO RELATED APPLICATIONS

This application claims the benefit of U.S. Provisional Application No. 62/090,795, filed Dec. 11, 2014.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### FIELD OF THE INVENTION

This invention is directed to a system for creating virtual arts and crafts venues across a global network. More particularly, the invention relates to such a system to support a hybrid structure to facilitate correlated interaction between physical and virtual arts and crafts venues.

### BACKGROUND

A plethora of e-commerce sites selling myriad different goods currently exist; AMAZON and EBAY are well-known examples. These sites are used to find various products at the best price. For art connoisseurs, although price can be a consideration, they are influenced to purchase by artistic impact, aesthetic quality, and perceived investment value of a piece of work.

Existing brick and mortar galleries, exhibits and arts and crafts fairs provide ranges and varieties of corresponding true physical representation of a piece of work, with each venue showing work for its intended target audience. In order to find art and other handmade creations, one must travel to a gallery, exhibit, or show. Part of the enjoyment of collecting anything is this ‘hunt and find’. However, some collectors seek specific pieces in a narrow combination of media, subject, age, area of origin, and/or physical size. Additionally, the specific artist and each piece of work can be contractually bound to a gallery or show and thus unavailable for other presentation venues. Galleries typically charge a commission of 30 to 50% of the sale price, and even rural weekend arts and crafts shows charge up to $1500 per weekend for an artist to exhibit and sell work at a tent or table.

Physical arts and crafts fairs are held throughout the world where one may stroll through the exhibits of a plurality of artists or artisans. Of course, one would expect that it would be difficult for an art lover living in Kansas City or St Paul to take a leisurely weekend trip to Paris, France to explore an art fair along the Seine. Even a weekend excursion from Cheyenne to Jackson Hole, Wyo. for a show can be a disappointment since more and more art show promoters are happy to accept booth fees for so-called artists to sell imported metal sculptures or digitally printed paintings. Generally, 10% of exhibitors in these shows make standout pieces and creations that, sadly, only the attendees of that show will ever see. The geographic hurdles and number of scattered “unknown” artists limits exposure between interested art lovers and artists.

Administratively, a physical art fair can implement a juried structure, which will constrain the fair to pieces matching a particular theme and/or specific quality standard. A juried exhibition relies on one or more individuals, i.e., a jury, to evaluate submitted works to select those deemed suitable for the fair. Some shows have criteria that accept only seasoned fine artists, so those juries also evaluate the various accepted works to determine which should receive coveted awards. Generally, a juried exhibition is a higher quality venue that may also charge admission to view the exhibits. Examples of juried exhibitions include the Royal Academy Summer Exhibition in London, the Chianciano Biennale at the Chianciano Museum of Art, and the Iowa Biennial, among many others.

Although juried exhibitions deliver higher quality submissions, access is limited by geographic proximity. In addition, participation by an artist can be expensive. Even where geographic proximity is not an issue, the effort for an artist to attend and sell at juried exhibits can be exhausting and stressful. To participate, an artist must submit works for consideration, travel to the show, obtain suitable and affordable lodging, set up merchandise, and beforehand, be sure that sufficient artwork has been created to justify attendance at the exhibition.

Every art fair has its own unique variables. Some may be poorly organized and administration may fail to control the overall venue, participants and attendees in an effective manner. Hence, an artist selling more diverse and genuinely unique works might end up in a booth next to a person selling sheets for $20 or someone offering cheap imported replicas of “handmade” items that have been marked up 600%.

Environmental factors clearly influence sales at physical art fairs. Inclement weather will cause attendance at a physical exhibition to suffer. Additionally, works can be damaged by heat, cold, humidity, dust, wind, rain, snow, hail, and other environmental factors. Inclement weather can jeopardize the artists' investment in attending the fair.

Physical art fairs necessarily expose the artists' works to attendees, some of which may not behave properly, such as an uncontrolled child or animal. Additionally, physical art fairs present a risk of theft of small works. Further, since an artist may not be able to preview an exhibitor or media list of fair participants, the artist may find that they have inadvertently promoted their wares at an exhibit or fair where the attendees are not particularly interested in their work, whether or not the show promoters have advertised to potential artists otherwise.

Artists are confronted with certain realities associated with physical art fairs. For example, in physical art fairs, at least two people are usually required to staff the tent. For the lone artist, this means long days without breaks. Additionally, the administrative and business aspects of generating revenue and profit can be daunting to an artist. Famously and historically, few artists care to be business-minded or even understand how to calculate profit. Most artists enjoy the process of creating their work, and if given the opportunity, would delegate the business side of their lives to someone else. These financial challenges can be overwhelming if the artists understand their true costs of doing business, and that they have to sell a minimum number of items to break even or possibly make a profit. The above considerations are enough to keep some of the most talented creators of our time from being “discovered” and rewarded for using their gifts and talent.

Long days, physical exhaustion and stress associated with displaying artwork at physical exhibitions and art fairs is not for the faint of heart. In an ideal environment, the artist would prefer to participate in an art fair venue with an idyllic park setting, perfect weather, and fun vendors that make one-of-a-kind items. They would seek to participate in art fairs where balance and complementary styles attract customers interested in each other's craft to the venue. Artists like to periodically meet potential buyers to get feedback and most need the satisfaction of seeing others enjoy the fruits of their labor.

There are a number of websites that promote the sale of artwork. However, to the best of the inventor's knowledge, none provides a juried approach where artists and imagery is intelligently cycled and correlated with actual brick and mortar physical galleries. For example, THE ART GUIDE (www.theartguide.com) provides a virtual gallery of thumbnail images for display of various paintings and images. ETSY (https://www.etsy.com) offers personal storefronts to thousands of creatives and associated support businesses. ETSY requires consistent long-term administration by the artist and does not offered a juried structure. ARTSTEPS (www.artsteps.com) is a web-based solution for a virtual exhibition that includes the ability to design and create a virtual gallery, upload artifacts and create exhibitions. VIRTUAL ART SPACE (www.3dvas.com) is a network of 3-D virtual spaces for displaying art on the internet. An artist interested in mounting an exhibition opens an account, chooses an appropriate exhibition space and uploads his or her artworks. BUZZ 3D (www.buzz3d.com) attempts to create an illusion of actually being inside the interior of a virtual art gallery. Graphtwerk (www.3dstellwerk.com) creates a virtual art gallery emphasizing 3-D viewing of objects. TRADKY (http://www.tradky.com/) provides a platform for delivery of an online virtual exposition. ARTSPACE (www.artspace.com) is another simplistic online presentation of two-dimensional artwork. The Art Fair Source Book (AFSB) (www.artfairsourcebook.com) is an online website that provides a listing of physical art fairs, craft shows and festivals. Another website, The Guild of Artists and Artisans (http://www.theguild.org/) likewise provides only information concerning physical art fairs.

In light of the aforementioned challenges associated with physical art fairs, there exists a need for a system that can hybridize, extend and amplify the beneficial features of a physical juried art fair within the flexible environment and easy accessibility of a virtual art fair.

### SUMMARY

The present invention comprises a computer and network implemented system to create, promote, optimize and manage virtual juried art fairs, creating an idyllic virtual environment for both artists and customers. The invention is directed to providing a non-traditional mechanism to support artists to more easily find and interact with people likely to enjoy and purchase their work. Thus, the system provides a conduit and platform to allow artists to more easily profit from their talent, thereby causing the entire artistic and creative industry to flourish. The system provides a structure to allow artists to find effective channels to reach an interested audience and generate sustainable income from the sale of their artwork.

The virtual art fair system according to the present invention provides a plurality of features and functions to address the needs and concerns of a participating artisan. First, the system eliminates the need for the artisan to transport works to the site of an actual physical fair. Second, the system avoids the expense associated with maintaining a tent at a physical art fair. Third, the system provides data from the virtual art fair, which an artisan can use to assess which pieces of work are most desirable. In addition, the system provides data to assist an artisan with inventory management, allowing informed decisions as to the appropriate level of physical inventory. The data gathered via the virtual art fair system further provides feedback to encourage the artisan to continue or discontinue development of additional media, subjects, styles, or other artistic variations with their work. Additionally, the virtual art fair system provides feedback that the artisan can use this to determine pieces of work to display at a physical art fair. This data aggregation and feedback afforded by the virtual art fair system increases the likelihood of higher sales at both virtual and physical art fairs.

The system requires computer implementation to support various features and functionality that would not otherwise be available. The system is comprised of a plurality of orchestrated software modules that may be viewable and accessible via a browser or native application across the Internet or equivalent network. Software modules include an orchestrator module, an administrative module, a jury module, a cycling module, a virtual exhibit module, a brick and mortar correlation module, a notification module, and an intellectual property protection module.

The orchestrator module manages the operation and functionality of the various software modules comprising the system. The administrative module manages the overall operation including the inventory of the artists and the display of their works in their virtual tents at the virtual art fair.

The jury module allows evaluation of artwork submitted for consideration by a jury of one or more evaluators. Based upon input from the jury, the jury module selects and determines which specimens should be selected and aggregated into various categories and themed virtual art fairs.

The cycling module ensures that the inventory of both artists and artwork remains fresh. Since most works sold through existing websites are duplicable, these websites tend to become stale due to regurgitation of the same inventory on a repeated basis. Additionally, these sites may have thousands of works through which one must search to find an item of interest. The cycling module tracks and monitors all works offered and exhibited through the virtual art fair. The cycling module ensures that a fresh inventory of both artists and works of art are presented to a virtual attendee. The cycling module places limits on the duration for which an artist may rent a tent in the virtual art fair, which is a significant differentiating feature of the present invention. The virtual art fair presented within this application limits both inventory and timeframe of an artist's presence at the fair. This unique feature will drive the customer to purchase immediately, and later look forward to a favorite artist's reappearance in the future.

The virtual exhibit module provides a platform for display of an artist's works and viewing of such work by a potential purchaser. The exhibit module provides templates that mimic, for example, a real-world tent at an art fair, a booth at a conference, a room in an art gallery or simply a table or other piece of furniture placed against a wall or other backdrop.

The brick and mortar correlation module supports correlation between objects displayed at a physical art fair and objects displayed in an associated virtual art fair. A calendaring module provides the artisan with the ability to optimize attendance at various physical art fairs most likely to promote the sale of the artisan's works. The calendaring module coordinates the overall schedule for virtual art fairs, both for artists and art fair promoters.

The system conveys the artistic essence and aesthetic quality of each piece of art to a potential purchaser. Since artwork can be both two-dimensional and three-dimensional, the system preferably includes a viewing module to support high-resolution two- and three-dimensional viewing of each artistic work.

The notification module presents notifications of every artist's rights and entitlements, including copyright, design, trademark, and other intellectual property rights, to users of the system. The notification module checks to ensure that clear notice of ownership and intellectual property rights is displayed throughout the virtual art fair, ensuring protection of artists' rights and discouraging unauthorized use of artistic content from the virtual art fair site.

The intellectual property protection module utilizes various digital web crawlers to search and identify potentially infringing use of artistic content on the Internet. The intellectual property protection module includes an automated feature to notify the artist of potentially infringing uses. The intellectual property protection module supplies the artist with access to multiple automated communication templates that an artist may trigger to gather additional information concerning the suspect user. Additional communication templates are provided to enforce his or her rights if the suspect use is deemed to rise to the level of infringement.

### BRIEF DESCRIPTION OF THE SEVERAL VIEWS OF THE DRAWINGS

These and other features, aspects and advantages of various embodiments of the present invention will become better understood with regard to the following description, appended claims, and accompanying drawings where:

FIG. 1 is a flowchart of the software modules associated with the virtual art fair system;

FIG. 2 is a flowchart illustrating the jury module associated with the virtual art fair system;

FIG. 3 is a flowchart illustrating the cycling module associated with the virtual art fair system;

FIG. 4 is a flowchart illustrating the brick and mortar correlation module associated with the virtual art fair system;

FIG. 5 is an exemplary view of a smaller type of tent for rent associated with the virtual art fair system; and

FIG. 6 is an exemplary view of a canopy for rent associated with the virtual art fair system.

The accompanying drawings numbered herein are given by way of illustration only and are not intended to be limitative to any extent. Commonly used reference numbers identify the same or equivalent parts of the claimed invention throughout the accompanying drawings.

### DETAILED DESCRIPTION

For artists, the virtual art fair system 10 of the present invention provides access to worldwide markets and exposure for their works of art. In one embodiment, the virtual art fair is a juried, year-round virtual art fair. On a continual basis, the virtual art fair system 10 rents virtual tents, booths, exhibit spaces, carts, wagons and table space to artists from all over the world. The system 10 controls the potential deluge of art that might be offered via the virtual art fair by implementing a juried assessment of each piece that allows only selected artists to show and sell a limited inventory of their works at the same time.

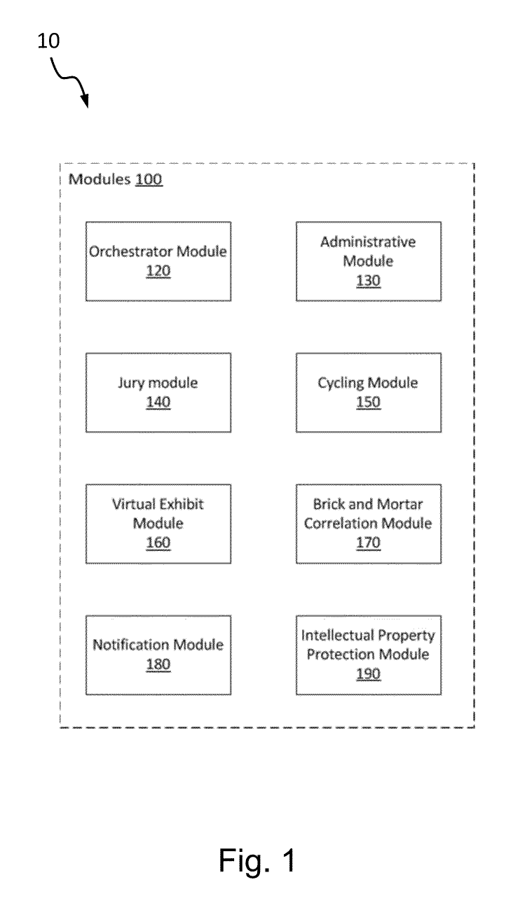

Referring to FIG. 1, the system 10 is comprised of a plurality of software modules 100 that are viewable and accessible via a browser or native application across the Internet or equivalent network. Software modules include an orchestrator module 120, an administrative module 130, a jury module 140, a cycling module 150, a virtual exhibit module 160, a brick and mortar correlation module 170, a notification module 180, and an intellectual property protection module 190.

The orchestrator module 120 manages the operation and functionality of the various software modules comprising the system 10.

The administrative module 130 manages the overall operation including the inventory of the artists and the display of their works in their virtual tents at the virtual art fair.

The jury module 140 allows evaluation of art work specimen submittals by individuals or groups of individuals, while the jury module 140 selects and determines which specimens should be selected and aggregated into categories and themed virtual art fairs.

The cycling module 150 ensures that the inventory of both artists and artwork remains fresh. Since most works sold through existing websites are duplicable, these websites tend to become stale due to regurgitation of the same inventory on a repeated basis. Additionally, these sites may have thousands of works through which one must search to find an item of interest. The cycling module 150 tracks and monitors all works offered and exhibited through the virtual art fair. The cycling module 150 manages the coordination of artists and their artwork to ensure that a fresh, limited inventory of both artists and works of art are presented to virtual attendees. The cycling module 150 places limits on the time for which an artist may maintain a virtual tent 20 in the virtual art fair. Forced time off ensures that the artist can be prepared to deliver new works in the future. It also generates recognition among customers that time is of the essence if they are interested in a specific piece of art. By restricting the purchasing window, customers will be aware that if they fail to purchase from existing inventory, they may be precluded from obtaining the work in the future.

The cycling module 150 also creates an additional advantage by limiting the works that an artist can sell at any virtual art fair. Once the virtual art fair has ended or the artist has sold all exhibited inventory, the scheduled virtual art fair tenancy is finished, and, there is no longer any need to monitor the event or those sales. The artist may always choose to maintain a separate e-commerce website, as there is opportunity for the artist to provide links from the virtual art exhibit to other online and physical appearances.

In addition, the cycling module 150 motivates an artist to create multiple original pieces of art rather than commit to reproduction of certain works ad nauseum. Once the virtual tent 20 is established, the artist can also use the tent 20 to test new ideas, launch new products and sell off inventory from previous craft shows and holiday bazaars. The restriction on inventory and purchase/sale window creates an incentive for each artist to focus on the creation of new and novel pieces, rather than reproduction of existing previously sold pieces.

The virtual exhibit module 160 provides a platform for display of an artist's works and viewing of such work by a potential purchaser. The exhibit module 160 provides templates that mimic, for example, a real-world tent at an art fair, a booth at a conference, a room in an art gallery or simply a table or other piece of furniture placed against a wall or other backdrop. Each exhibit may be configured to support scale and lighting in a manner desired by the artist. The artist populates an exhibit space with any of his or her pieces of art by simply taking an image of the piece of work with her smartphone, tablet or digital camera, then uploading the image to his or her specimen repository. The quality of the image is dependent on the artist's ability to best photograph their work.

The brick and mortar correlation module 170 supports correlation between objects displayed at a physical art fair and objects displayed in an associated virtual art fair. An administrator of a physical venue can elect to extend access to the works displayed at that physical venue for a longer duration via the correlated virtual art fair. Thus, a potential customer that may have elected not to purchase a piece of art at the physical fair, but then later decides to purchase the piece, can now elect to attend the virtual art fair and attempt to purchase the piece of art if it is still available.

For example, the system 10 allows the interest of attendees at a physical art fair to drive sales and inventory presented at the correlated virtual art fair. In one embodiment, at the physical art fair, as part of the brick and mortar correlation module 170, a barcode or other digital identifier is provided in close proximity to a piece of art. An attendee can scan the barcode, which will then cause the phone's browser to provide immediate access for the customer directly to the website of the virtual art fair. With this information, in addition to the inventory physically present in the artist's tent, a customer can obtain information on other works created by the particular artist. This expands the purchasing opportunities for the customer and the sales opportunities for the artist, as well as the commission opportunities for the promoter/organizer of the physical art fair.

In one embodiment, the system 10 is implemented in a manner to support access via any web browser or as a native application on desktop computers and other computing platforms. The browser-based solution is further extended to support mobile applications for smartphones and tablets. The system interface, whether viewed via a website or through a bespoke native mobile application, allows one or more virtual spaces to be rented to one or more approved artists, providing a temporary venue for each artist to sell his or her works. The system 10 causes the virtual tents to be scaled to support the sale of a similar amount of inventory that an artist would normally have for sale at an outdoor art or craft fair. Merchandise sold can be of any type and price.

In one version, considered consistent with typical inventory found at an outdoor physical art or craft fair, merchandise can include, for example, handmade, limited editions of work including jewelry, pottery, sculpture, carvings, photography, leatherwork, painting, lithographs, numbered prints and other limited-production methods. An aspect of the system 10 is the prevention of inclusion of mass produced items, in favor of handmade, one-of-a-kind pieces of art or craft.

To ensure satisfactory consumer response and ensure that customer orders are fulfilled promptly, the system 10 allows artists to exhibit and sell works that are either already completed, or, can be completed in time to ship within a prescribed time period, such as two days. In addition, to maintain the novelty associated with items offered for sale via the virtual art fair, the system 10 constrains each artist to the sale of a limited inventory at any time. By restricting the inventory allowed for sale and displaying current inventory in real-time, the system 10 will entice customers to purchase a piece of art immediately or miss the opportunity to obtain the artist's work. Once the inventory is sold, the artist is not allowed to rent a virtual tent 20 again for a proscribed period, such as one month. This gives the artist fast sales results, allows time to focus on the creative process, and creates demand for the artist's work.

The virtual art fair system 10 simplifies display and sale by artists. In operation and use, the system 10 provides an interface and portal through which one or more artists may sign up and rent a virtual tent 20 at a selected virtual art fair. In one version, each artist commits to making a limited number of pieces to sell at their tent. The artistic pieces can include, for example, watercolors, oils, mixed media, books, pottery, jewelry, paper arts, metalwork, or sewn pieces, among others. Assuming the artist's work has been accepted for inclusion in the virtual art fair via the jury module 140, the artist submits a photo of each piece of artwork and the system 10 causes the photo to be displayed in his or her own tent 20 or booth in the idyllic virtual park setting. In other versions, rather than simply displaying a two-dimensional photo, the system 10 accepts and presents three-dimensional views of specific works.

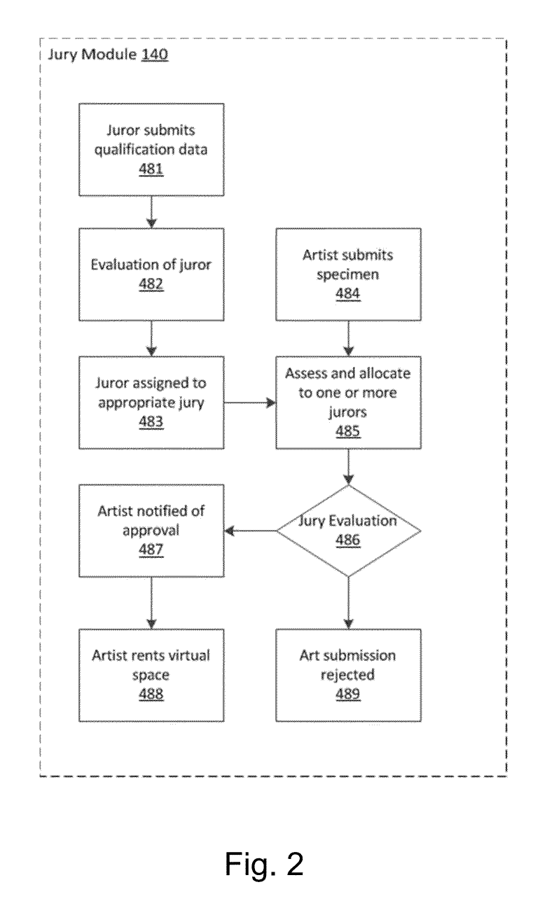

Referring to FIG. 2, a flowchart illustrating the function of the jury module 140 is described in greater detail. The jury module 140 provides a mechanism by which individuals or groups of individuals may independently assess submitted art specimens while the jury module 140 aggregates, orders and categorizes the art specimens for inclusion in one or more virtual art fairs. The jury module 140 processes and evaluates data describing the background and interests of one or more judges to designate each judge for inclusion in juries relevant to their backgrounds, experience, skills and tastes.

An artist submits an image of a specimen of art to the system 10 in step 484. The jury module 140 assesses the image based upon information supplied by the submitting artist and then allocates further assessment of the specimen to one or more jurors in step 485. Each juror will then rank the specimen in a jury evaluation step 486 according to several subjective and objective factors. These factors include, among others, novelty, quality, uniqueness, subject matter, improvement, beauty, skill, inherent meaning, fulfilled intent, price and subjective preference.

The jury module 140 expands its capacity to manage an ever-increasing number of submitted specimens and the judges required to assess the specimens. The jury module 140 ensures that the jury process can scale to avoid bottlenecks to ensure that a virtual art fair universe can be created and scaled to any size over time without restricting the ability of artists to promptly deploy, present and offer their works.

Each artist will submit photos of the works he or she intends to sell. In addition, each artist will submit physical other relevant data associated with the submitted work, including, for example, actual physical dimensions of the work along with price. This information is then processed via the jury module 140 in step 484. Any information submitted by the artist and any photos may be maintained in a secure, password-protected repository. Once images and photos are posted on the virtual fair website, the images and photos are locked so viewers cannot copy or share the works. A security function of the virtual art fair system 10 is intended to avoid copying of an artist's works; one method used is digital watermarks.

As submittals are received, in one version, the jury comprised of multiple individuals collaboratively reviews and discusses those works selected by the jury module 140 to make a subjective determination as to whether the selected submittal is truly congruent and complementary with the particular virtual art fair's target market and theme. In order to serve as a juror, an individual must submit qualification data in step 481 for consideration. Such qualification data may include a resume or curriculum vitae, prior experience as an art juror, and publications or other academic qualifications. The juror is evaluated in step 482 and, if selected as a juror, assigned to an appropriate jury in step 483 to evaluate submissions. Example criteria used by the judges include quality, marketability, uniqueness, relevance, style, appeal, and subjective taste of each judge, among others. If more than one artist has similar products, (two quilters, for example) each artist will be given slots to rent in different time slots, to avoid product saturation. The jury module 140 receives selected submittals and incorporates an adjusted ranking of those selected specimens in its knowledge base to enhance future recommendations to the jury.

To expedite formation of each art fair, exhibitors receive notice within a specified period, e.g., 24 hours, whether or not their work has been selected and deemed eligible for sale on the virtual art fair site in step 487. The jury module 140 quickly processes the submitted specimens for final judgment by the jury to ensure a rapid turnaround.

An artist whose works have been selected is then allowed to rent a virtual space in the virtual art fair in step 488. For clarity, we refer to the virtual space as a virtual tent 20, but the virtual space could also constitute a booth, a table, a platform, a room, a wall or other display areas. The amount of rent paid will be driven by the size of tent, the amount of artist biographical information displayed, and other marketing benefits chosen. Size refers in one instance to the number of photo thumbnail images the artist wants in his or her virtual space. In another instance, size refers to how much computer screen space is required. Further, in another instance, size refers to the amount of data associated with an artist's displayed collection and/or memory or bandwidth required to effectively display and present an artist's presence in the virtual art fair system. As in physical real-world art shows, artists can choose to have a particular base-size booth, such as 10-foot by 10-foot, for the base cost, and pay extra for such items as a table skirt, chairs, power access, desirable locations (e.g., corner booth versus back-of-the-room), and more.

If, after the jury evaluation step 486, the subjective and objective evaluation factors are not met, the art submission is rejected in step 489. Depending on the administrator setting, the artist may be allowed the opportunity to make changes and resubmit the work for evaluation.

Virtual tent space is offered to each artist on a limited time basis only. The system 10 allows the administrator of the virtual art fair to move and rearrange the tents' positions on the site pages to keep interest and intrigue for guests and visitors to the site. The tent rental will end when either the artist's inventory is sold out (best scenario) or after a week, two weeks, or a month. Depending on demand for space, the duration of rental may increase or decrease.

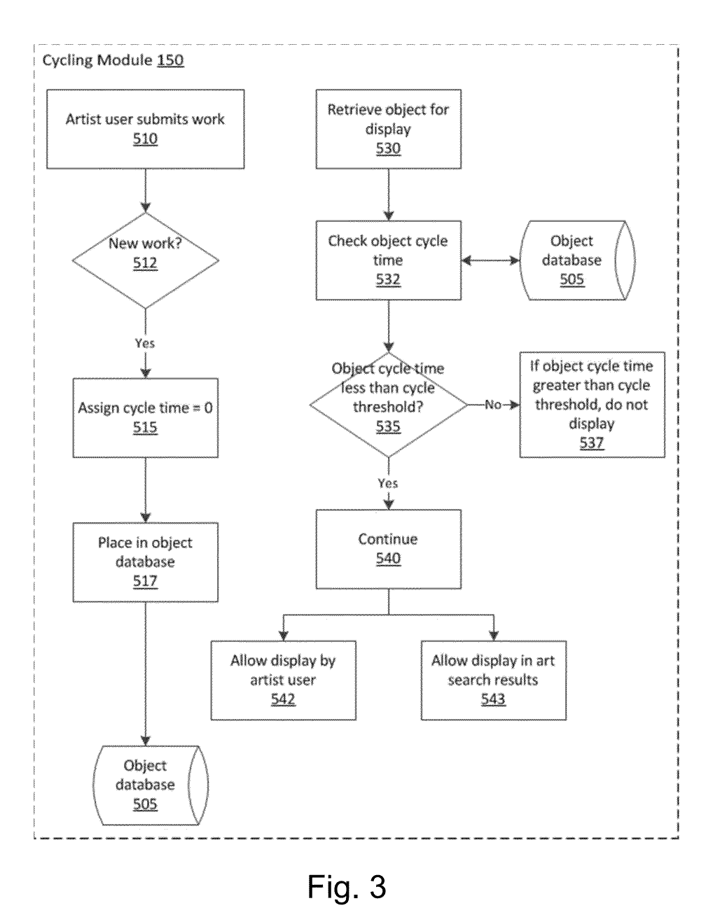

Referring to FIG. 3, a flowchart illustrating the function of the cycling module 150 is described in greater detail. The cycling module 150 ensures that the inventory of both artists and artwork remains fresh. First, an artist submits a new work in step 510. The work is submitted to the cycling module 150 either after the work has been accepted via the jury module 140, or, simply uploaded. In step 512, the cycling module 150 determines whether the work is a new work. If yes, the new work is assigned a cycle time of zero in step 515. The submitted work is placed in object database 505 in step 517. The cycling module 150 retrieves the submission for display in step 530. This may be a request from a search or a visit to a virtual tent 20 by an attendee or customer. In step 532, the object cycle time corresponding to the work is checked from the object database 505. In step 535, the cycling module 150 checks whether the object cycle time is less than the cycle threshold. This threshold may be set by an administrator of the virtual art fair. If the object cycle time is greater than the cycle threshold, the cycling module 150 will prevent the work from displaying in step 537. If the object cycle time is less than the cycle threshold, the cycling module 150 continues in step 540. Allowed actions include allowing display of the work by the artist user to the attendee in step 542 and allowing display of the work in search results in step 543.

In one version, the rental transaction is consummated via an electronic payment method such as PAYPAL. All financial aspects are handled by certified third-party providers. This ensures transaction simplification and confidence in the financial management of the system. Once payment for a virtual tent 20 is received by the administrator, the artist then sends the administrator the digital images and associated information of the inventory items to be sold. The images and information may be transmitted via email or by a separate file upload feature associated with the system 10.

Once the images and information are received, the administrator will populate the artist's virtual tent template with the product images and information. When a customer chooses an art piece to purchase, the system 10 places the item in the customer's digital shopping cart. Items in the cart may be from various tents. The administrative module 130 will collect the total amount due for all the items via the electronic payment system. As an artist notifies the administrator that the item has been shipped to the customer, the administrator will release payment to the artist. Notification to facilitate payment may include evidence of shipment by a carrier, including a tracking number that the administrative module 130 can use for verification.

The payment system, requiring release of payment by the administrator only after notification and verification, allows the virtual art fair promoter to monitor the artist/customer experience. With this administrative oversight, the administrator can set a professional tone, emphasizing the need for artists to respond to customers promptly to receive payment promptly. This administrative oversight feature will minimize the likelihood of a potentially negative experience between artists and their customers, thus increasing the likelihood of success of each virtual art fair.

In addition, once an artist sends a purchased piece of art directly to the customer, the system 10 allows the artist-customer relationship to progress so that a customer can elect to purchase additional work from the artist. By maintaining and developing a positive business relationship, the system 10 further facilitates opportunities for the customer to possibly commission work from an artist, independent of the artist's participation in the virtual art fair venue. Consequently, the system 10 acts as a catalyst to nurture additional works and sales of those works through other channels.

In another version, the rental transaction is still consummated via an electronic payment method such as PAYPAL, but the artist is paid directly by the customer, rather than relying on an administrative facilitator. Once payment for the virtual booth is received by the administrator, the artist then sends via email or other digital communication the code for his or her own PAYPAL button. The code for the artist is posted for easy access on the virtual booth next to each item being sold by the artist. The artist is paid directly by the person purchasing the artwork. All financial aspects are handled by third-party providers. This ensures transaction simplification and confidence in the financial management of the system. Once an artist receives payment for a piece of work, the artist sends the art directly to the customer and maintains the customer relationship directly. The expense associated with use of the virtual art fair is preferably less than the aggregate cost of a physical art fair. To participate in a physical art fair, an artist has to buy a booth, travel to the show, set up, sit at a booth for days in the rain, and hope that the right customer will walk by and pay attention to the artist's great work.

The system 10 showcases the work of each artist alongside the work of many other artists in the virtual art fair. For the art lover, i.e., the customer, the system 10 provides a website or native application where the customer can simply browse the art showcase to discover artists and their work. The virtual venue delivers perfect weather, 24/7 monitoring, and worldwide exposure.

When shopping at a virtual art fair site, guests can become fans of various artists. The system 10 allows artists to be featured on the site based on various criteria, including the number of fans they may have. This approach encourages social media involvement initiated by the artists as well as their fans.

Each piece of digital artwork will have meta tags or other digital attributes that enable a guest to search for “watercolor sailboat” or “Montana horizon in oil,” for example. In other versions, guests are required to register as “members” or pay “admission” to the fair. Customized emails will be sent regularly to existing or potential customers offering limited time promotions.

In another version, to purchase an item, a guest will first click on the picture of an item they want to purchase. That action will prepare and transmit an email to the artist regarding purchase of that specific piece. The guest will enter his or her own email address to communicate the desire to purchase to the artist. The artist will be responsible for calculating shipping costs and possible sales taxes to charge the customer and process the purchase, for example, via the artist's PAYPAL or merchant account.

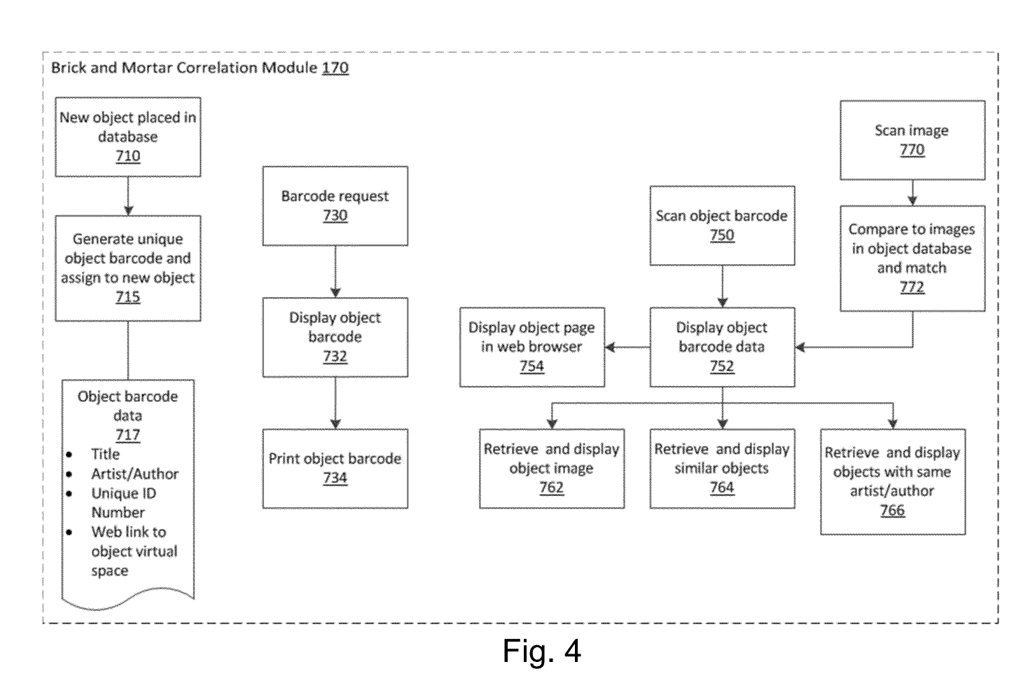

Referring to FIG. 4, an illustration of the operation and function of the brick and mortar correlation module 170 is described. First, a new object is placed in object database 505 in step 710. This may occur when an artist has a submission accepted via the jury module 140 and places the artwork in a virtual tent 20. The brick and mortar correlation module 170 generates a unique object barcode and assigns it to the new object in the database in step 715. The barcode contains object barcode data 717, which may include data such as the title of the work, the artist or author, a unique identification number assigned by the module, and/or a web link to the corresponding virtual space, such as the work description page or the virtual tent. The barcode is an optical machine-readable representation of data and may be in the form of a linear barcode or a matrix barcode, such as a QR code.

Next, artists may present a unique barcode, generated by the brick and mortar correlation module 170, in close proximity to the corresponding piece of art in a physical art fair or gallery display. The artist makes a barcode request in step 730. The brick and mortar correlation module 170 displays the object barcode in step 732 to the artist, who has the option to print the object barcode in step 734. An attendee may then scan the barcode in step 750 with a barcode scanner or mobile device, which will then display the object barcode data retrieved by the system 10 in step 752. The attendee is provided with a web link for a smart phone or other mobile device to access the corresponding work in the virtual art fair. The object page can be displayed in the attendee's web browser in step 754, and the attendee can be provided with a 2-D or 3-D representation of the original artwork by retrieving and displaying the object image in step 762.

With this information, in addition to the inventory physically present in the artist's virtual tent 20, an attendee or customer can obtain information on other works created by the particular artist in step 766. This expands the purchasing opportunities for the customer and the sales opportunities for the artist, as well as the commission opportunities for the promoter/organizer of the physical art fair. Further, the correlation module 170 supports retrieval and display of similar objects in step 764. Similarity criteria can be based on juror evaluation criteria scores for each object produced by the jury module 140. If a barcode is not available or not implemented, the attendee may take a picture of the artwork and upload the image to the virtual art fair site in step 770. The image is analyzed, compared, and matched with the corresponding work in the object database 505 in step 772, taking the user to the relevant web page and information in the corresponding virtual space.

A virtual art fair administrator coordinates each fair and leases virtual space to each artist to allow him or her to show and sell his or her work. Each artist can set his or her own prices for their pieces, interact with their customers, make the sale transactions and deliver the work to their customer. The security of the system 10 prevents any party from capturing information associated with the artist's customers. Each transaction with a customer is secured via the use of e-commerce payment systems such as PAYPAL.

The administrator never maintains inventory of any sort and thus never competes with any artist. Since the administrator does not maintain inventory, for returns, the customer works directly with the artist. In the event there arise any issues with existing artists or customers, the system administrator will first attempt to mediate between parties, and may resolve to lock out the problematic person from access to the site.

In another version of the system 10, a hybrid approach leveraging presence at a physical art fair is provided. Although the physical art fair may include a plethora of artists, those artists whose pieces have been selected for display in a virtual art fair are provide with an entitlement to display information concerning their participation in and access to the virtual art fair. Since the virtual art fair is a juried presentation, a structure of awards and recognition is provided to identify those artists and pieces of work that the members of the jury deem to be outstanding or warranting certain recognition for one of a number of reasons, including novelty, quality, uniqueness, subject matter, improvement, etc.

Only those artists who have been selected by the jury for inclusion in the virtual art fair will be entitled to display a poster or other award that indicates their participation in the virtual art fair.

Once an artist has been selected for participation in the virtual art fair, he or she is able to purchase different sized virtual tents 20 in which to display their work. Pricing of each virtual tent 20 can be driven by various criteria. Criteria may include the size of the virtual tent 20, the value of the inventory to be displayed, the configuration of the virtual tent 20, the importance or significance of the particular art fair, the caliber of the other participants in the art fair, the caliber of the invited attendees, the digital look and feel of the virtual tent 20, and other features which may add value to the virtual experience. Typically, the size of each virtual tent 20 will be correlated to the size of an actual physical tent. The size of the artwork as displayed in the virtual tent 20 will likewise be scaled to correspond to size of an actual physical tent. Since there is a correlation between the size of the virtual tent 20 and the number of pieces that may be displayed, the artist is motivated to display only those pieces of higher quality and artistic value. Thus, an artist will not be tempted to place a plethora of items in the virtual tent 20. Hence, since all virtual pieces of art have an inherent scale that correlates to the scale of the virtual tent 20, each artist will use his or her judgment as to which pieces to include. The system 10 will not allow the artist to place more pieces in the virtual tent 20 than can be actually held in a physical tent based on scaling to size. Just as an artist would be inclined to pay for a physical tent to display only priority pieces of art, the virtual art fair system 10 ensures that the artists do not wantonly post every item in their possession in their virtual tent 20 on the website.

The system 10 provides archival storage for retention of any imagery associated with an artist's earlier two and three-dimensional views of each piece of art. The artist has access to the archival storage, which may be used to store newer pieces of art until the artist elects to display their works in a suitably sized virtual tent 20. This provides the ability for each artist to “move” his or her artistic work to storage only once.

The system 10 includes functionality to support continued real-time implementation of the juried aspect of the virtual art fair via an extended implementation of the jury module 140.

In the present system 10, various persons are selected to act as judges or connoisseurs of various forms of art. These judges use different methods to assess various artistic works for suitability for inclusion in the virtual art fair.

In another implementation of the jury module 140, judges travel to and review artistic works at actual physical art fairs. While reviewing the works of the various artists, and with an artist's approval, a judge will collect initial imagery concerning pieces of interest, which can be considered by other judges. The judge physically present at the physical art fair will take one or more photos of the piece of interest for transmittal to a virtual repository that is accessible by other judges with the appropriate authority. To avoid concerns that the imagery is being used by a judge to copy rather than promote a specific artistic work, a judge will provide a written digital assurance and contract to the artist. The contract will provide that any such imagery will be destroyed if the artist's work is not selected for inclusion in the virtual art fair. Once relevant images of the artistic work have been taken by the judge, preferably with a higher resolution camera or smartphone, the images are uploaded to the system 10 where the imagery is co-registered and rendered to create a high-resolution two or three-dimensional image of the artistic work. In addition to uploading the imagery, the judge will also include biographical information and other relevant data concerning the artist and his or her various works. Such data could include quality, marketability, uniqueness, relevance, style, appeal, and subjective taste of the judge, among others.

Once an artist's work has been selected for inclusion in the virtual art fair, the system 10 includes an approval process for the artist to ensure that the information and imagery are correct and displayed in a desired manner. The system 10 will provide access to the virtual tent 20 designed and configured by the virtual art fair administrator for review and final approval by the artist. Once the virtual tent design is approved by the artist, he or she then agrees to pay certain amounts for the entitlement of displaying and selling his or her works through the virtual art fair system 10. If the artist elects not to participate and does not provide final approval of the virtual tent design, subject to final notice to the artist, the system 10 will delete all imagery, including any 3-D imagery from all digital repositories. The system 10 will send a separate email notice to the artist confirming the destruction and deletion.

The system 10 will allow authorized parties to have access to change the content and imagery within an artist's virtual tent 20. Typically, authorized parties will include the virtual fair administrator and the artist. The artist will have limited ability to reconfigure placement of his or her works, but will have the ability to control other aspects, such as narrative descriptions, pricing and replacement of works that have been sold.

The system 10 will allow customers to peruse and purchase items. Customers will not have authority or ability to change any aspect of the artist's virtual tent 20. In addition, the system 10 includes safeguards that restrict the ability of a potential purchaser to copy and print any imagery from the artist's virtual tent 20 without prior approval from the artist, which might also include certain fees for such rights.

The system 10 includes a notification module 180 to ensure that every artist's rights and entitlements, including copyright, design, trademark, and other intellectual property rights, are notably presented to each potential customer. The notification module 180 checks to ensure that clear notice of ownership and intellectual property rights is displayed throughout the virtual art fair to ensure that each artist's rights are protected to minimize the temptation for a party to inappropriately use any artistic content from the virtual art fair site.

In another aspect, the system 10 includes an intellectual property protection module 190 comprised of various digital web crawlers to search out and identify potentially infringing use on the Internet. The intellectual property protection module 190 includes an automated feature to notify the artist of a potentially infringing use. The intellectual property protection module 190 supplies the artist with access to multiple automated communication templates that an artist may trigger to gather additional information concerning the suspect user. Additional communication templates are provided to enforce his or her rights if the suspect use is deemed to rise to the level of infringement.

The system 10 provides each visitor to a virtual art fair site with additional functionality in return for registration. During registration, the system 10 collects certain information to develop a visitor's connoisseur profile.

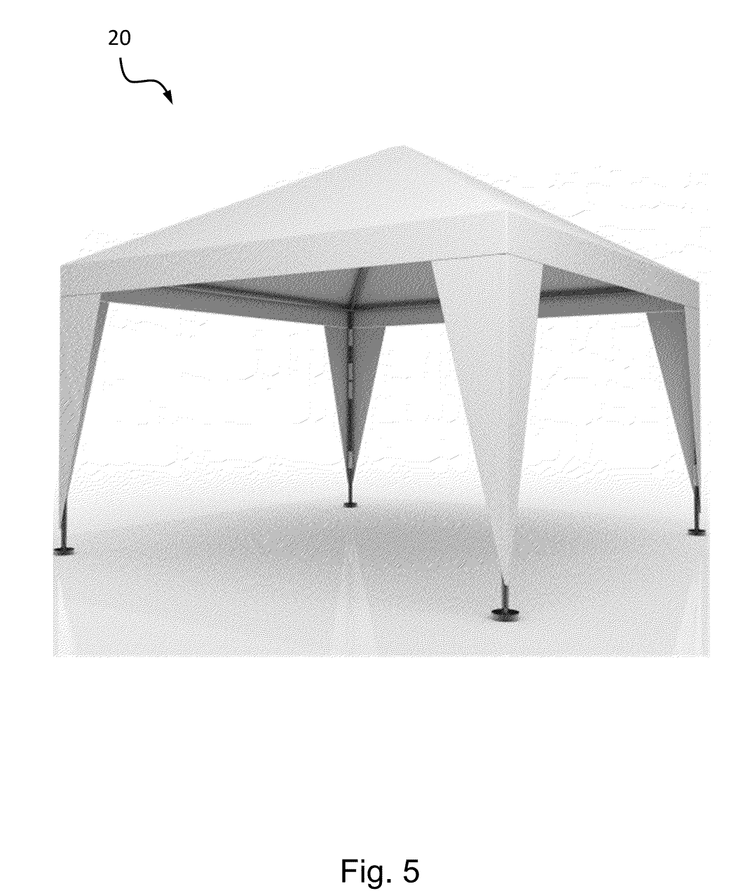

FIG. 5 is an exemplary illustration of an artist's virtual tent 20. The virtual tent 20 is typical of what one might encounter at a physical art fair. The virtual tent 20 is shown as an open tent. The virtual tent 20 can be easily converted to a booth simply by adding sides to the virtual tent 20, which create more of an enclosed space. Once a customer enters a virtual tent 20, each artistic work can be accessed separately by an interested visitor for more detailed viewing in a higher resolution two-dimensional or dynamic three-dimensional view. The three-dimensional view allows the customer to manipulate the work to see aspects of interest and to see the work from different perspectives and with different lighting effects.

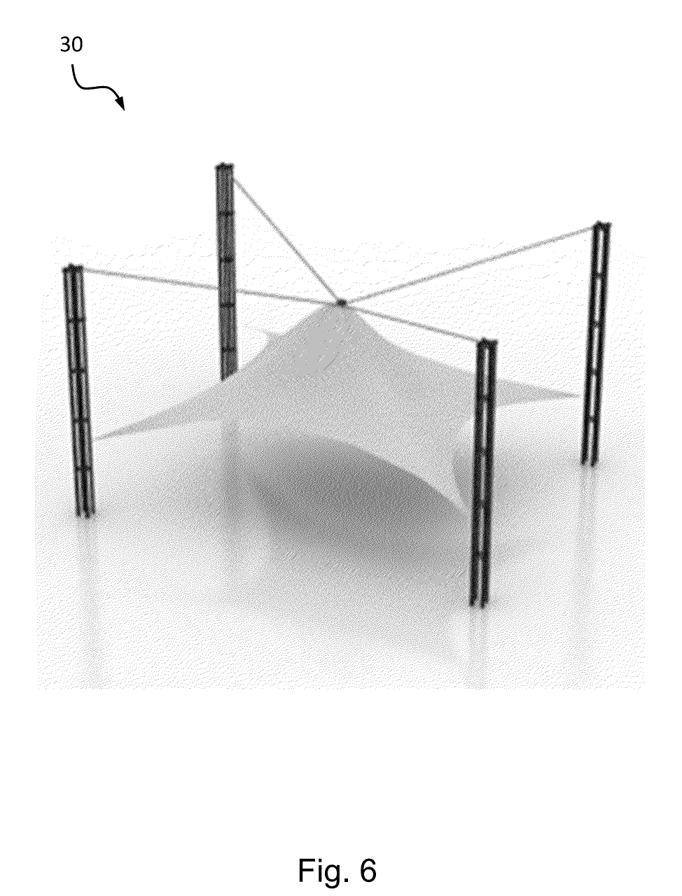

FIG. 6 is an illustration of a virtual canopy 30 associated with the virtual art fair system 10. The virtual canopy 30 is sized to accommodate a number of virtual tents 20. In addition, where a particular artist or seller may have a sizeable collection of works, the virtual canopy 30 provides a larger virtual footprint to house the artist's or seller's larger collection.

Each virtual tent 20 is intended to provide virtual display of an artist's works. Consequently, in addition to the inclusion of the artist's works, the virtual tent 20 can include texture and backgrounds that correspond to what one would encounter when visiting at a physical art fair. The system 10 also supports digital variation of attributes for each virtual tent 20; each artist is able to configure their own virtual tent 20 to have customized features and properties. Depending on the level of customization, each virtual tent 20 can be designed by each artist to serve as an additional artistic work as long as the final design comports with guidelines provided by the administrator to ensure usability of the site by prospective customers.

To ensure that the digital repository used as an archive for an artist's work is readily available for access by the artist, the artist's archival repository is preferably supported via a secure cloud service. The system 10 includes a customized secure cloud implementation for managing the many works of art submitted for consideration and display.

In another version, the virtual art fair system 10 is configured as a hybrid physical digital gallery wherein a physical gallery is comprised of a plurality of high-resolution displays able to present imagery of each artist's works. In the hybrid version, the physical gallery consists of a physical space within which are deployed a plurality of display screens. For example, the equivalent virtual tent 20 may equate to a single digital display screen, which provides various imagery of an artist's work. The display screen may be supplemented by one or more representative physical pieces that are presented in front of the display screen. This hybrid version provides a compromise between a strictly virtual art fair and a strictly physical art fair.

The present invention has been particularly shown and described with respect to certain preferred embodiments and features thereof. However, it should be readily apparent to those of ordinary skill in the art that various changes and modifications in form and detail may be made without departing from the spirit and scope of the inventions as set forth herein.

1. A computer and network implemented system to create, promote, optimize and manage virtual juried art fairs, comprising a plurality of orchestrated software modules wherein said orchestrated software modules may be accessible and viewable via a web browser or native application across the Internet or equivalent network.

2. The system of claim 1 wherein said software modules include:
a. an orchestrator module;
b. an administrative module;
c. a jury module;
d. a cycling module;
e. a virtual exhibit module;
f. a brick and mortar correlation module;
g. a notification module; and
h. an intellectual property protection module.

3. The system of claim 2 wherein said orchestrator module manages the operation and functionality of said software modules.

4. The system of claim 2 wherein said administrative module manages the overall operation of the virtual art fair including inventory of an artist and the display of said artist's works in virtual tents within the virtual art fair.

5. The system of claim 2 wherein said jury module manages evaluation of artwork submitted by one or more artists for consideration by a jury of one or more evaluators, said jury module selecting and evaluating one or more art specimens and aggregating said art specimens into one or more categories and associating said art specimens with one or more virtual art fairs.

6. The system of claim 2 wherein said cycling module cycles an inventory of artists participating in the virtual art fair and the artwork of said artists based on duration limits.

7. The cycling module of claim 6 wherein said cycling module places and manages said duration limits on the duration for which an artist may rent a tent in the virtual art fair.

8. The cycling module of claim 6 wherein said cycling module places and manages said duration limits on inventory of an artist.

9. The system of claim 2 wherein said virtual exhibit module provides a virtual platform for display of an artist's works and viewing of such work by a potential purchaser, said virtual platform providing two-dimensional and three-dimensional displays an artist's works wherein said displays mimic real-world environments.

10. The virtual exhibit module of claim 9 wherein said displays include a tent at an art fair, a booth at a conference, a room in an art gallery, a table, and a piece of furniture placed against a backdrop.

11. The system of claim 2 wherein said brick and mortar correlation module drives and manages correlation between objects displayed at a physical art fair and objects displayed in an associated virtual art fair.

12. The system of claim 11 wherein said calendaring module optimizes attendance of an artist at one or more physical art fairs and coordinates attendance at physical art fairs with participation in virtual art fairs to maximize artist exposure and to enhance the mix of artists for promoters of virtual and physical art fairs.

13. The system of claim 2 wherein said viewing module delivers high-resolution two-dimensional and three-dimensional viewing of each artistic work to convey the artistic essence and aesthetic quality of each piece of art to a potential purchaser.

14. The system of claim 2 wherein said notification module presents one or more notifications of each artist's rights and entitlements to users of the system to ensure that clear notice of ownership and intellectual property rights are displayed throughout the virtual art fair, thereby ensuring protection of artists' rights and discouraging unauthorized use of artistic content from the virtual art fair site.

15. The system of claim 2 wherein said intellectual property protection module manages one or more digital web crawlers to search for and identify potentially infringing use of an artist's artistic content on the Internet and generate automated notices to potential infringers to enforce the artist's rights.
